(19) United States
(12) Patent Application Publication
(10) Pub. No.: US 2026/0339938 A1
(43) Pub. Date: Oct. 29, 2026

(54) ARTIFICIAL INTELLIGENCE-ASSISTED AND AUTOMATED VERIFICATION FOR USER-DEFINED FUNCTIONS TO STRUCTURED QUERY LANGUAGE TRANSLATION

(71) Applicant: Microsoft Technology Licensing, LLC, Redmond, WA (US)

(72) Inventors: Tarique Ashraf SIDDIQUI, Redmond, WA (US); Arnd Christian KÖNIG, Kirkland, WA (US); Shuvendu Kumar LAHIRI, Sammamish, WA (US); Jiashen CAO, Seattle, WA (US)

(21) Appl. No.: 19/192,768

(22) Filed: Apr. 29, 2025

(51) Int. Cl. G06F 16/2452; G06F 16/242

(52) U.S. Cl. CPC G06F 16/24522; G06F 16/2448

(57) ABSTRACT

The present disclosure relates to systems and methods for translating a structured query language (SQL) with a user-defined function (UDF) into a translated SQL query using a machine learning model. The systems and methods automate a verification of the translated SQL query establishing an equivalence between the translated SQL query and the UDF.

### BACKGROUND

User-defined functions (UDFs) extend the capabilities of structured query language (SQL) by improving code reusability and encapsulating complex logic but can hinder the performance due to optimization and execution inefficiencies. Existing solutions attempt to address the inefficiencies of UDFs by rewriting UDFs into native SQL, which is inlined into the SQL queries that invoke the UDFs.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes receiving a parent structured query language (SQL) query with a user-defined function (UDF), wherein the UDF is written in a programming language different from SQL. The method includes translating, using a large language model (LLM), the UDF into a translated SQL query. The method includes compiling the translated SQL query into a logical plan. The method includes generating verification conditions for the logical plan. The method includes translating the UDF into an intermediate verification language. The method includes providing a verification result in response to performing a verification process of the verification conditions and the intermediate verification language.

Some implementations relate to a device including a memory to store data and instructions; and a processor operable to communicate with the memory, wherein the processor is operable to: receive a parent structured query language (SQL) query with a user-defined function (UDF), wherein the UDF is written in a programming language different from SQL; translate, using a large language model (LLM), the UDF into a translated SQL query; compile the translated SQL query into a logical plan; generate verification conditions for the logical plan; translate the UDF into an intermediate verification language; and provide a verification result in response to performing a verification process of the verification conditions and the intermediate verification language.

Some implementations relate to a computer-readable storage medium including instructions that, when executed by a processor, cause the processor to: receive a parent structured query language (SQL) query with a user-defined function (UDF), wherein the UDF is written in a programming language different from SQL; translate, using a large language model (LLM), the UDF into a translated SQL query; compile the translated SQL query into a logical plan; generate verification conditions for the logical plan; translate the UDF into an intermediate verification language; and provide a verification result in response to performing a verification process of the verification conditions and the intermediate verification language.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for using a query rewriting tool in accordance with implementations of the present disclosure.

FIG. 2 illustrates an example verification workflow in accordance with implementations of the present disclosure.

FIG. 3 illustrates an example method for verifying translated SQL queries in accordance with implementations of the present disclosure.

FIG. 4 illustrates components that may be included within a computer system in accordance with implementations of the present disclosure.

### DETAILED DESCRIPTION

This disclosure generally relates to structured query language (SQL) queries with user-defined functions (UDFs). SQL is a programming language for storing and processing information in a relational database. Database systems offer procedural extensions, such as UDFs with support for various programming languages (e.g., PYTHON, T-SQL, C #) to broaden the scope of declarative SQL. UDFs extend the capabilities of SQL by improving code reusability and encapsulating complex logic. UDFs are procedural code embedded within declarative SQL that helps specify complex logic and improve modularity and code reusability.

UDFs can hinder the performance of the SQL query due to optimization and execution inefficiencies. UDFs have limited query optimization opportunities. It can be challenging to infer the properties of UDFs needed to optimize UDFs. UDFs are also slow to execute due to computational and data transfer overheads, particularly when the UDF is written in a language different than the SQL dialect supported by the database, resulting in UDFs having orders of magnitude slower performance than equivalent SQL queries.

Existing solutions attempt to address the inefficiencies of UDFs by rewriting UDFs into native SQL, which is inlined into the SQL queries that invoke the UDFs. However, existing solutions are either limited to simple pattern matching or require the synthesis of complex verification conditions from procedural code. It can be difficult to infer SQL from complex multi-line UDF statements and match patterns in the UDF. Existing solutions are limited in coverage and less extensible to unseen procedural constructs with processes that are brittle and difficult to automate.

The present disclosure includes systems and methods that leverage large language models (LLMs) to translate UDFs to native SQL. The systems and methods receive a parent SQL query with code for a UDF and provide the code with the UDF to the LLM. The parent SQL query is a combination of the UDF and a SQL query invoking the UDF. The LLM translates the UDF into SQL and generates a translated SQL query. The systems and methods use a verification method to establish equivalence between the UDF and the translated SQL query (the LLM-generated SQL). The systems and methods verify that the translated SQL query is equivalent to the UDF. For example, the translated SQL query is equivalent to the UDF if the translated SQL query provides the same result as the UDF for any input data set. The systems and methods inline the translated SQL query with the parent SQL query and use the inlined SQL query in responding to the parent SQL query if the verification process determines that the translated SQL query is equivalent to the UDF. The present disclosure includes a number of practical applications that provide benefits and/or solve problems associated with SQL queries with UDFs. Examples of these applications and benefits are discussed in further detail below.

One example benefit of the systems and methods is automated verification of UDFs and LLM-generated SQL. Another example benefit of the systems and methods is significant performance improvements in query responses. Another example benefit of the systems and methods is broader coverage and higher extensibility. New operators or functions can be supported by the systems and methods by adding corresponding verification conditions without needing to alter existing operations or the verification approach. The systems and methods model various imperative constructs in an intermediate verification language, capturing the imperative constructs during the verification process. The function repository used by the systems and methods provides a concise representation to add new functions. Another example benefit is use of the systems and methods with queries involving UDFs tuned offline, such as via a generative AI assistant or for recurring queries.

In some implementations, the code for the UDF is written in the PYTHON programming language. PYTHON is an object-oriented programming language with dynamic semantics. The systems and methods provide the PYTHON code to the LLM and the LLM generates a translated SQL query with a SQL expression for the UDF written in the PYTHON code.

In some implementations, the systems and methods leverage generative AI models for converting the parent SQL query into the translated SQL query. Examples of generative AI models include Generative Pre-trained Transformer (GPT) machine learning models (e.g., GPT-3 or GPT-4), LlaMA, and GEMINI. Generative AI models generate content, such as text, images, video, audio, or other data in response to a question or prompt. Another example of a generative AI model includes multi-modal models. In some implementations, the question or prompt is multi-modal input, and the generative AI model processes the multi-modal input to generate content. For example, the generative AI model receives non-text input and generates an output of text. Another example includes the generative AI model receives text input and generates a non-text output. Generative AI models learn the patterns and structure of the input training data and generate new data that has similar characteristics to the input data in response to prompts based on the instructions in the prompts.

In some implementations, the systems and methods use few-shot prompting tailored to different categories of UDFs and use context from the parent query and database schema for translating the UDF into the translated SQL. The LLM uses the instructions in the few-shot prompt in translating the UDF into the translated SQL.

In some implementations, the systems and methods generate a logical plan for the translated SQL. The systems and methods compile or optimize the translated SQL and generate the logical plan. The logical plan represents the UDF as a sequence of operators and identifies how the operators are combined in the UDF. For example, the logical plan is represented as an acyclic graph of (logical) operators (and functions). In some implementations, the systems and methods generate a verification structure using the logical plan and performs the verification process verifying that the verification structure and the UDF are equivalent.

In some implementations, the systems and methods translate the UDF to an intermediate verification language and the verification process compares the intermediate verification language to the verification structure. For example, the intermediate verification language is BOOGIE. BOOGIE is a modeling programming language that is used for the representation of the source UDF during the verification. In some implementations, the systems and methods use Hoare-triplets during the verification process. The verification process ensures that for any given input, the translated SQL query provides the exact same output as the UDF query.

Upon successful verification, the systems and methods use the translated SQL query in providing a query result to the parent SQL query, improving query processing time while maintaining accuracy of the query result. A successful verification includes the verification process verifying that the translated SQL query is equivalent to the UDF. Upon an unsuccessful verification (the verification process fails), the systems and methods use the parent SQL query in providing a query result ensuring the accuracy of the query result. An unsuccessful verification includes the verification process is unable to verify that the translated SQL query is correct. For example, an unsuccessful verification occurs when the translated SQL query provides a different result (not equivalent) than the UDF.

One technical advantage of the systems and methods of the present disclosure is improving performance of executing SQL queries using UDFs. The systems and methods reduce computational overhead resulting in improved query performance while maintaining accuracy of the query results. Another technical advantage of the systems and methods of the present disclosure is improving resources used for executing SQL queries using UDFs. The systems and methods reduce the frequency of out-of-memory errors. The systems and methods reduce translation overheads by using the LLM to translate the UDF into SQL. Another technical advantage of the systems and methods of the present disclosure is automatically verifying equivalence between LLM-generated SQLs and UDFs.

The systems and methods perform automatic inlining of UDFs within SQL queries using machine learning models. The systems and methods translate UDFs into equivalent SQL expressions and perform a verification to ensure that the translated SQL expression are equivalent (e.g., provide the same results) as the original UDFs.

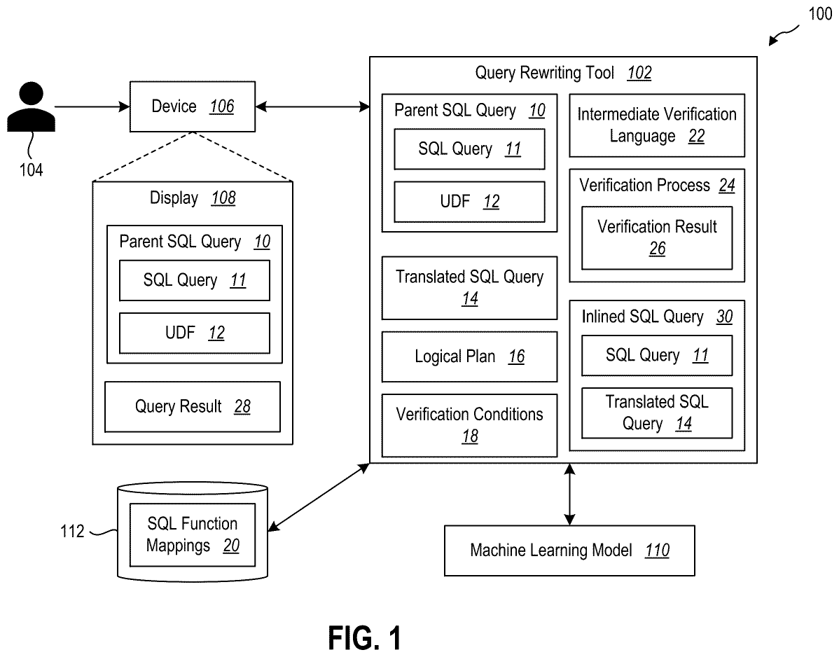

Referring now to FIG. 1, illustrated is an example environment 100 for using a query rewriting tool 102 for translating a UDF 12 in a parent SQL query 10 into a translated SQL query 14. The parent SQL query 10 is the combination of the UDF 12 and a SQL query 11 invoking the UDF 12. UDFs are procedural code embedded within declarative SQL that helps specify complex logic and improve modularity and code reusability. One example UDF is a PYTHON Scalar UDF used for row-wise transformations within SQL queries, maintaining a one-to-one relationship between input and output. Another example UDF is a PANDAS Scalar UDF used in processing entire columns as inputs, enabling more efficient analysis. Another example UDF is an aggregation UDF that is specialized for complex data summarization tasks, accepting multiple inputs to produce a singular, aggregated output. Another example UDF is a Map UDF that takes an entire table as input and outputs a table.

In some implementations, a user 104 provides the parent query 10 with the SQL query 11 and the UDF 12 using a device 106. For example, the user 104 provides the parent query 10 using a user interface on a display 108. The device 106 may be representative of one or multiple devices and may refer to various types of computing devices. For example, the device 106 may include a mobile device such as a mobile telephone, a smartphone, a personal digital assistant (PDA), a tablet, a laptop, or any other portable device. Additionally, or alternatively, the device 106 may include one or more non-mobile devices such as a desktop computer, server device, or other non-portable device. In some implementations, the device 106 may be communicatively coupled (e.g., wired or wirelessly) to the display 108 having a user interface thereon providing a display of system content.

The query rewriting tool 102 is in communication with the device 106 via a network. In some implementations, the query rewriting tool 102 is on a cloud server remote from the device 106 accessed through the network. For example, the query rewriting tool 102 is hosted on virtual machines in the cloud. The network may include one or multiple networks and may use one or more communication platforms and/or technologies suitable for transmitting data. The network may refer to any data link that enables transport of electronic data between devices of the environment 100. The network may refer to a hardwired network, a wireless network, or a combination of a hardwired network and a wireless network. In one or more implementations, the network includes the Internet. The network may facilitate communication between the various computing devices. The server may include one or more computing devices (e.g., including processing units, data storage, etc.) organized in an architecture with various network interfaces for connecting to and providing data management and distribution across one or more client systems. While one device is illustrated, the query rewriting tool 102 may be in communication with a plurality of devices. In some implementations, the query rewriting tool 102 is accessed through a server address configured to an end point of the query rewriting tool 102 provided to the device 106 that an application on the device 106 of the user 104 accesses. In some implementations, the query rewriting tool 102 is local to the device 106.

The query rewriting tool 102 receives the parent SQL query 10 with the SQL query 11 and the UDF 12 and provides the UDF 12 to a machine learning model 110. In some implementations, the machine learning model 110 is a large language model. For example, the machine learning model 110 is GPT 3.5 or GPT 4. The machine learning model 110 receives the UDF 12 and generates a translated SQL query 14 for the UDF 12 using the code translation capability of the machine learning model 110. Using the machine learning model 110 simplifies the translation process of the UDF 12 and expands the scope of SQL query synthesis.

In some implementations, the query rewriting tool 102 identifies a UDF type for the UDF 12 from the query syntax and provides the machine learning model 110 a few-shot learning prompt created for the UDF type. In some implementations, each UDF type has a pre-created few-shot learning prompt with instructions tailored to a category of the UDF type and the query rewriting tool 102 selects the few-shot learning prompt for the UDF type of the UDF 12 included in the parent SQL query 10. In some implementations, the few-shot learning prompts include relevant metadata from parent queries (e.g., an item mapping to a column) and contextual examples of UDF to SQL translations. The machine learning model 110 uses the instructions in the few-shot learning prompt in translating the UDF 12 into the translated SQL query 14.

The query rewriting tool 102 compiles the translated SQL query 14 into a logical plan 16. The logical plan 16 represents the translated SQL query 14 as a sequence of operators and identifies how the operators are combined. In some implementations, the logical plan 16 is represented as an acyclic graph of logical operations that accurately captures the data processing within the translated SQL query 14. The dependencies between operations in the logical plan 16 mirror the dependencies between code segments of the UDF code.

The query rewriting tool 102 uses SQL function mappings 20 in generating verification conditions 18 for the logical plan 16. The SQL function mappings 20 map the SQL operators to function properties. SQL has well-defined semantics. In some implementations, the SQL operators and functions properties are modeled offline using uninterpreted functions and stored in a datastore 112 accessible by the query rewriting tool 102. Examples of uninterpreted functions include UCONCAT for CONCAT_WS, USPLIT for SPLIT, UFILTER for FILTER. The verification conditions 18 for the logical plan 16 are generated as a composition (following the same flow defined in the logical plan 16) of the uninterpreted functions.

The query rewriting tool 102 also translates the UDF 12 into an intermediate verification language 22. The intermediate verification language 22 is used in verifying an equivalence of the UDF 12 and the translated SQL query 14 generated by the machine learning model 110. One example of the intermediate verification language 22 is the BOOGIE programming language. In some implementations, the query rewriting tool 102 uses a multi-step translation process. Each step in the translation processes involves custom transformations on the abstract syntax tree (AST) of the UDF 12 to translate the AST into the syntax of BOOGIE code while preserving the semantics of the UDF 12.

The query rewriting tool 102 performs a verification process 24 that matches the verification conditions 18 to the intermediate verification language 22. For example, the verification process 24 matches the name and parameters of the uninterpreted functions in the verification conditions 18 to the operators in the verification language 22. In some implementations, the verification language 22 is the BOOGIE programming language and the uninterpreted functions are in BOOGIE code. For each operator with potential procedural implementations inside the UDFs (e.g., inside a loop), the verification process 24 maintains properties that capture the semantics of the operation. For example, the verification process 24 performs a syntactic analysis of the BOOGIE code used in verification and identifies functions within a loop inside the BOOGIE code. The verification process 24 instantiates (e.g., identify parameter values of) the property functions and use them as invariants for verification.

In some implementations, the verification process 24 builds complete Hoare triplets using the post-conditions and invariants synthesized from SQL in the verification conditions 18 and invokes an inbuilt verifier in the BOOGIE programming language to confirm correctness.

The verification process 24 outputs a verification result 26 indicating an outcome of the verification process 24. In some implementations, the verification result 26 indicates a successful verification. A successful verification occurs when the verification conditions 18 are equivalent to the intermediate verification language 22. For example, the uninterpreted functions in the verification conditions 18 provide the same results as the functions included in the intermediate verification language 22 for any possible inputs. Examples of a verification result 26 indicating a successful verification is an output of true or a number “1.”

In some implementations, the verification result 26 indicates an unsuccessful verification. An unsuccessful verification occurs when the verification process is unable to verify equivalence of the UDF 12 and the translated SQL query 14. One example of an unsuccessful verification includes the verification results 26 indicates that the verification conditions 18 are not equivalent to the intermediate verification language 22. For example, the uninterpreted functions in the verification conditions 18 provide different results as the functions included in the intermediate verification language 22 for an input. Examples of a verification result 26 indicating an unsuccessful verification is an output of false or a number “0.”

Upon a successful verification (the verification result 26 indicating a successful verification), the translated SQL query 14 is inlined into the parent SQL query 10 replacing the UDF 12 with the translated SQL query 14. The inlined SQL query 30 is used in providing a query result 28 to the parent SQL query 10. The inlined SQL query 30 includes the SQL query 11 and the translated SQL query 14. The query result 28 is presented on the display 108. Using the translated SQL query 14 in providing the query result 28, improves query execution time while maintaining accuracy of the results. In some implementations, the translated SQL query 14 is used in place of the UDF 12 in other applications. The translated SQL query 14 is typically faster and consumes fewer resources as compared to the UDF 12. Upon an unsuccessful verification (the verification result 26 indicating an unsuccessful verification), the parent SQL query 10 with the UDF 12 is used to provide the query result 28 presented on the display 108 maintaining accuracy of the query results 28.

The environment 100 translates the UDF 12 into a translated SQL query 14 using a machine learning model 110 and uses the semantics of operators in SQL for verification of the translated SQL query 14 ensuring that the translated SQL query 14 is equivalent to the UDF 12. The environment 100 translates the UDF 12 into the translated SQL query 14 accurately and provides performance improvements in providing query results 28 to SQL queries 11 invoking UDFs 12. In some implementations, one or more computing devices (e.g., servers and/or devices) are used to perform the processing of the environment 100. The one or more computing devices may include, but are not limited to, server devices, cloud virtual machines, personal computers, a mobile device, such as a mobile telephone, a smartphone, a PDA, a tablet, or a laptop, and/or a non-mobile device. The features and functionalities discussed herein in connection with the various systems may be implemented on one computing device or across multiple computing devices. For example, the query rewriting tool 102, the machine learning model 110, and the datastore 112 are implemented on a single computing device. Moreover, in some implementations, one or more subcomponents of the features and functionalities discussed herein may be processed on different server devices of the same or different cloud computing networks. For example, the query rewriting tool 102, the machine learning model 110, and the datastore 112 are implemented on different server devices.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

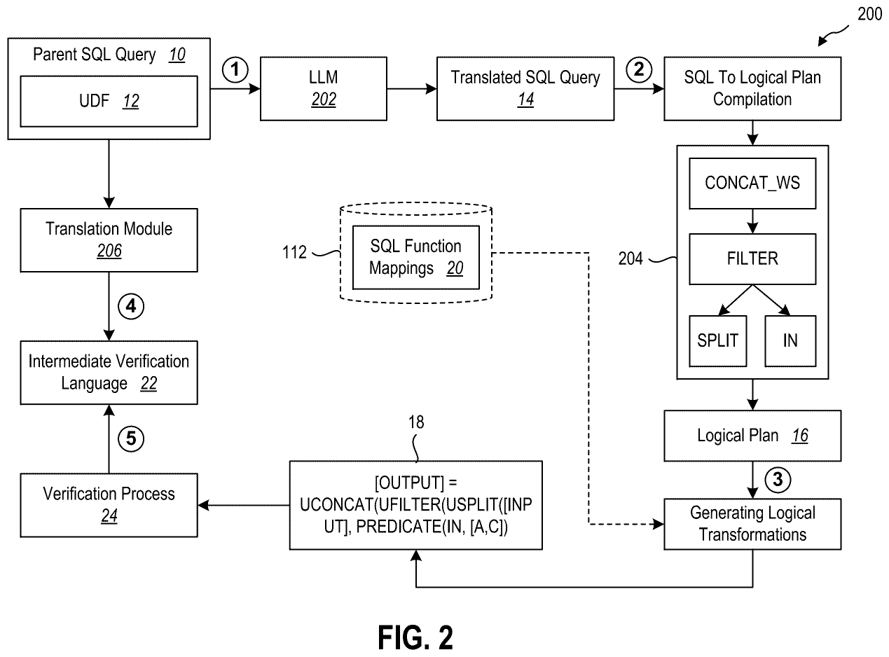

FIG. 2 illustrates an example verification workflow 200. In some implementations, the query rewriting tool 102 (FIG. 1) uses the verification workflow 200 in verifying a UDF 12 is equivalent to a translated SQL query 14.

At 1, the verification workflow 200 includes an LLM call 202. The LLM call 202 includes the UDF 12. For example, the query rewriting tool 102 provides the LLM call 202 to the machine learning model 110 (FIG. 1) and the machine learning model 110 translates the UDF 12 into the translated SQL query 14. For example, the translated SQL query 14 is inferred by the machine learning model 110. In some implementations, the LLM call 202 includes a few-shot learning prompt selected based on a type of the UDF 12 and the machine learning model 110 uses the instructions in the few-shot learning prompt in translating the UDF 12 into the translated SQL query 14. In some implementations, the LLM call 202 includes contextual examples of UDF to SQL translations and the machine learning model 110 uses the contextual examples in translating the UDF 12 into the translated SQL query 14. In some implementations, the LLM call 202 includes relevant metadata from the parent SQL query 10 and the machine learning model 110 uses the relevant metadata in translating the UDF 12 into a translated SQL query 14. For example, the relevant metadata includes the schema of all referenced tables, as well as column data types, and the types of all variables input to the UDF 12. In some implementations, the LLM call 202 includes any combination of the few-shot learning prompt, contextual examples, and relevant metadata.

At 2, the verification workflow 200 includes converting the translated SQL query 14 into a logical plan 16. For example, the query rewriting tool 102 converts the translated SQL query 14 into the logical plan 16 by optimizing the translated SQL query 14. Another example includes the query rewriting tool 102 converts the translated SQL query 14 into the logical plan 16 by compiling the translated SQL query 14.

In some implementations, the logical plan 16 is an acyclic graph 204 of logical operations capturing the data processing within the UDF 12. Each operation corresponds to a segment of the UDF code and the dependencies between operations (illustrated by edges in the graph). In the illustrated example, the acrylic graph 204 is generated as a result of the compilation of the translated SQL query 14. The bottom-up flow of operations SPLIT, then FILTER (taking as input the output of SPLIT, and a conditional IN expression), and finally CONCAT (taking as input the output of FILTER and a delimiter string) capture the corresponding expressions in the UDF 12.

At 3, the verification workflow 200 includes generating logical transformations of the logical plan 16 into verification conditions 18. The logical operations and functions in SQL have defined semantics. In some implementations, the logical operations are modeled offline using uninterpreted functions and stored as SQL function mappings 20 in a datastore 112. The query rewriting tool 102 accesses the datastore 112 and uses the SQL function mappings 20 in generating the logical transformations of the logical plan 16 into verification conditions 18. For example, the query rewriting tool 102 traverses the logical plan 16 and generates the verification conditions 18 as a composition (following the same flow defined in the logical plan 15) of the uninterpreted functions obtained from the SQL function mappings 20.

At 4, the verification workflow 200 includes translating the UDF 12 into an intermediate verification language 22. In some implementations, the query rewriting tool 102 uses a translation module 206 in translating the UDF 12 into the intermediate verification language 22.

In some implementations, the UDF 12 is written in PYTHON code, the intermediate verification language 22 is BOOGIE code, and the translation module 206 is a custom PYTHON-to-BOOGIE translation component. The translation module 206 applies a series of transformations to translate the PYTHON code of the UDF 12 into semantically equivalent BOOGIE code. Each transformation is defined as a rewrite rule operating on the abstract syntax tree (AST) of the PYTHON code for the UDF 12 that is triggered when one or more pre-conditions are satisfied. In some implementations, the pre-conditions involve the entirety of the AST (e.g., a pre-condition can require that a variable be assigned once). Since all transformations preserve the semantics of the AST, the transformations can be applied in any order by the translation module 206.

One example transformation includes converting lists and dictionaries into BOOGIE-compatible arrays. Another example transformation includes converting all loops into BOOGIE-compatible while loops with explicit conditions and iterators. Another example transformation includes rewriting generator expressions and list comprehensions as loops with equivalent iterators. Another example transformation includes translating function and method calls, including library functions, into BOOGIE uninterpreted function calls with relevant axioms. Another example transformation includes translating data frame operations either into equivalent PYTHON code and, subsequently, through other transformations, to BOOGIE code, or modeling relational operators through equivalent uninterpreted functions over special relation and column types. Another example transformation includes mapping functions on data types not native to BOOGIE (e.g., DateTime) using uninterpreted functions.

In some implementations, the translation module 206 infers types during translation. Since BOOGIE is statically typed, unlike PYTHON, the translation module 206 infers types during the transformation. The types of input parameters to the UDF 12 are inferred by looking up the types of corresponding columns from the database schema. The types for variables derived within the UDF 12 are inferred using rules based on the operations and the types of columns on the right side of the assignment. The return types of functions can be inferred from the function repository. If the type of any variable is ambiguous, the verification is considered unsuccessful and the query rewriting tool 102 provides a verification result 26 (FIG. 1) of unsuccessful.

In some implementations, the translation module 206 models the semantics of a UDF 12 with DataFrames. When a DataFrame is passed as input to the UDF 12, the DataFrame corresponds to a table wherein column labels match the table's column names. Each column in a DataFrame is modeled as a BOOGIE array. When the UDF 12 does not specify columns explicitly, the columns can be inferred from the parent SQL query 10. For each column, the translation module 206 adds a variable representing the number of rows, allowing the translation module 206 to translate row iterators into offset-based iterators and types are inferred.

Operations within DataFrames, such as column manipulations, aggregations, filtering, and transformations, are translated into a PYTHON-equivalent set of instructions (and then to BOOGIE) or uninterpreted functions (if implementation is unnecessary). Unlike standard PYTHON code, arithmetic and logical operations on DataFrames have unique semantics and are therefore modeled using uninterpreted functions. Operations that introduce new columns or modify DataFrames, are modeled using uninterpreted functions.

At 5, the verification workflow 200 includes performing a verification process 24 of the verification conditions 18. For example, the query rewriting tool 102 verifies the post-conditions or invariants included in the verification conditions 18 by comparing the verification conditions 18 to the intermediate verification language 22 (e.g., the BOOGIE code).

In some implementations, the mappings between functions and the corresponding uninterpreted functions are stored in the datastore 112. For many commonly used library functions in PYTHON UDFs, there exists equivalent functions in SQL, which are correctly identified by the machine learning model 110 during the translation of the UDF 12 from PYTHON into SQL. The functions with unknown source code are stored in a function repository in the datastore 112 to track the required equivalencies between PYTHON functions and SQL functions, as well as capture any additional semantics required for the verification. For example, the mappings between PYTHON functions and the corresponding uninterpreted functions are stored in the SQL function mappings 20 in the datastore 112 and the query rewriting tool 102 uses the mappings in performing the verification process 24. If a match occurs, the verification process 24 indicates that the BOOGIE code and the verification conditions 18 provide the same result. In some implementations, the verification process 24 ensures semantic equivalence of the verification conditions 18 and the BOOGIE code and that for any possible input, the same results are provided. In some implementations, the verification process 24 uses Hoare-style verification to establish semantic equivalence between the verification conditions 18 and the BOOGIE code. If the match does not occur, the verification process 24 is unsuccessful. One example of an unsuccessful verification process 24 includes the BOOGIE code and the verification conditions 18 produce different results. Another example of an unsuccessful verification process 24 includes the verification process 24 is unable to verify the equivalence of the verification conditions 18 and the BOOGIE code.

In some implementations, the SQL function mappings 20 capture the following information: PYTHON function, parameters, types, and return types; an equivalent SQL function, parameters, and types; BOOGIE uninterpreted function representing the PYTHON function; additional code required to encode the BOOGIE uninterpreted function in BOOGIE; and any additional axioms required for verification. The query rewriting tool 102 uses the information from the SQL mappings 20 in mapping pairs of equivalent functions in the UDF 12 written in PYTHON to a canonical uninterpreted function in the BOOGIE code. The query rewriting tool 102 uses axioms to capture necessary or additional semantics for verification. The query rewriting tool 102 supports composability of functions with other expressions in the UDF 12 via generated BOOGIE code (can be multiple lines, captures input and output variables). In some implementations, additional library functions can be registered for extensibility without changes to other parts of the query rewriting tool 102 supporting extensibility.

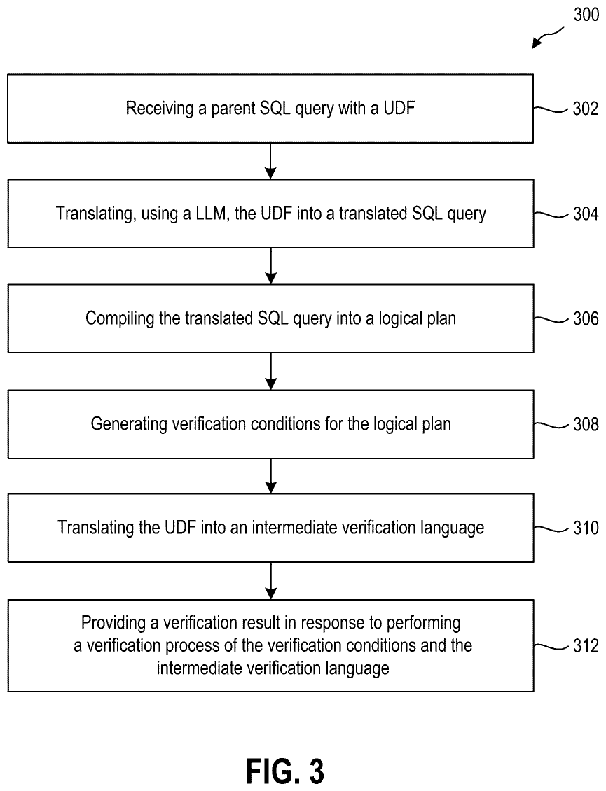

FIG. 3 illustrates an example method 300 for verifying translated SQL queries in accordance. The actions of the method 300 are discussed below in reference to FIGS. 1 and 2.

At 302, the method 300 includes receiving a parent SQL query with a UDF. In some implementations, the query rewriting tool 102 receives a parent SQL query 10 with a UDF 12 and a SQL query 11 invoking the UDF 12. For example, the query rewriting tool 102 receives the parent SQL query 10 from a user 104. Another example includes the query rewriting tool 102 receives the parent SQL query 10 from an application on a device 106. In some implementations, the UDF 12 is written in a programming language different from SQL. One example of the programing language is the PYTHON programming language. Another example of the programming language is T-SQL. Another example of the programming language is C #.

At 304, the method 300 includes translating, using a LLM, the UDF into a translated SQL query. In some implementations, the query rewriting tool 102 translates the UDF 12 into a translated SQL query 14 using a LLM (e.g., the machine learning model 110). For example, the LLM is a generative machine learning model.

At 306, the method 300 includes compiling the translated SQL query into a logical plan. In some implementations, the query rewriting tool 102 compiles the translated SQL query 14 into a logical plan 16. In some implementations, the logical plan 16 indicates a combination of operations in the translated SQL query 14 and represents the translated SQL query 14 in a sequence of operations.

At 308, the method 300 includes generating verification conditions for the logical plan. In some implementations, the query rewriting tool 102 generates verification conditions 18 for the logical plan 16. In some implementations, the verification conditions 18 are a composition of uninterpreted functions identified by using SQL function mappings 20 to SQL operator function properties and using equivalence rules.

At 310, the method 300 includes translating the UDF into an intermediate verification language. In some implementations, the query rewriting tool 102 translates the UDF 12 into an intermediate verification language 22. In some implementations, the intermediate verification language is different from the programming language used for the UDF and SQL.

In some implementations, the intermediate verification language 22 is BOOGIE code and the UDF 12 is written in PYTHON code and the PYTHON code is translated into the BOOGIE code by performing a series of transformations that preserve the semantics of the PYTHON code. For example, the series of transformations are applied in any order. In some implementations, the PYTHON code is translated into the BOOGIE code by inferring types of input parameters to the UDF 12. For example, the query rewriting tool 102 translates the PYTHON code into the BOOGIE code.

At 312, the method 300 includes providing a verification result in response to performing a verification process of the verification conditions and the intermediate verification language. In some implementations, the query rewriting tool 102 provides a verification result 26 in response to performing a verification process 24 of the verification conditions 18 and the intermediate verification language 22.

In some implementations, the verification result 26 indicates that the verification process 24 is successful and that functions in the verification conditions 18 provide the same result as functions in the intermediate verification language 22. In some implementations, the method 300 further includes using the translated SQL query 14 in place of the UDF 12 in response to the verification result 26 indicating that the verification process 24 is successful. For example, the translated SQL query 14 is used in a variety of applications in place of the UDF 12.

In some implementations, the method 300 includes inlining the translated SQL query 14 with the parent SQL query 10 in response to the verification results 26 indicating that the verification process 24 is successful. For example, inlining the translated SQL query 14 with the parent SQL query 10 includes replacing the UDF 12 with the translated SQL query 14. In some implementations, the method 300 includes executing an inlined SQL query 30 with the SQL query 11 and the translated SQL query 14 in providing a query result 28 to the parent SQL query 10. For example, the query result 28 is presented on a display 108 in response to the user 104 providing the parent SQL query 10 with the UDF 12.

In some implementations, the verification result 26 indicates that the verification process 24 is unsuccessful and that functions in the verification conditions 18 provide a different result as compared to functions in the intermediate verification language 22. In some implementations, the method 300 includes using the parent SQL query 10 with the UDF 12 in providing a query result 28 in response to the verification result 26 indicating that verification process 24 is unsuccessful.

The method 300 establishes the equivalence of the UDF 12 with the translated SQL query 14. Using the translated SQL query 14 in providing the query result 28 improves query processing time. Accuracy is ensured in the query result 28 by verifying the equivalence of the UDF 12 and the translated SQL query 14.

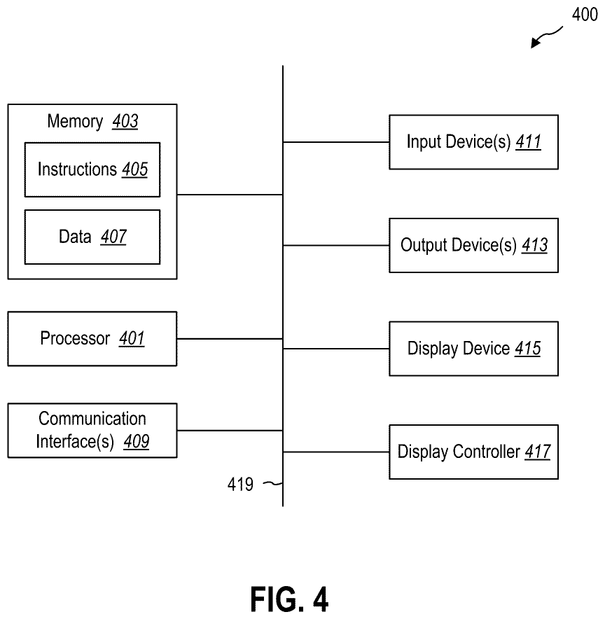

FIG. 4 illustrates components that may be included within a computer system 400. One or more computer systems 400 may be used to implement the various methods, devices, components, and/or systems described herein.

The computer system 400 includes a processor 401. The processor 401 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 401 may be referred to as a central processing unit (CPU). Although just a single processor 401 is shown in the computer system 400 of FIG. 4, in an alternative configuration, a combination of processors (e.g., an ARM and DSP) could be used.

The computer system 400 also includes memory 403 in electronic communication with the processor 401. The memory 403 may be any electronic component capable of storing electronic information. For example, the memory 403 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 405 and data 407 may be stored in the memory 403. The instructions 405 may be executable by the processor 401 to implement some or all of the functionality disclosed herein. Executing the instructions 405 may involve the use of the data 407 that is stored in the memory 403. Any of the various examples of modules and components described herein may be implemented, partially or wholly, as instructions 405 stored in memory 403 and executed by the processor 401. Any of the various examples of data described herein may be among the data 407 that is stored in memory 403 and used during execution of the instructions 405 by the processor 401.

A computer system 400 may also include one or more communication interfaces 409 for communicating with other electronic devices. The communication interface(s) 409 may be based on wired communication technology, wireless communication technology, or both. Some examples of communication interfaces 409 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 400 may also include one or more input devices 411 and one or more output devices 413. Some examples of input devices 411 include a keyboard, mouse, microphone, remote control device, button, joystick, trackball, touchpad, and lightpen. Some examples of output devices 413 include a speaker and a printer. One specific type of output device that is typically included in a computer system 400 is a display device 415. Display devices 415 used with embodiments disclosed herein may utilize any suitable image projection technology, such as liquid crystal display (LCD), light-emitting diode (LED), gas plasma, electroluminescence, or the like. A display controller 417 may also be provided, for converting data 407 stored in the memory 403 into text, graphics, and/or moving images (as appropriate) shown on the display device 415.

The various components of the computer system 400 may be coupled together by one or more buses, which may include a power bus, a control signal bus, a status signal bus, a data bus, etc. For the sake of clarity, the various buses are illustrated in FIG. 4 as a bus system 419.

In some implementations, the various components of the computer system 400 are implemented as one device. For example, the various components of the computer system 400 are implemented in a mobile phone or tablet. Another example includes the various components of the computer system 400 implemented in a personal computer. Another example includes the various components of the computer system 400 implemented in the cloud. Another example includes the various components of the computer system 400 implemented on an edge device.

As illustrated in the foregoing discussion, the present disclosure utilizes a variety of terms to describe features and advantages of the systems and methods. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining, and the like. Also, “determining” can include receiving (e.g., receiving information), accessing (e.g., accessing data in a memory), and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A method comprising:
receiving a parent structured query language (SQL) query with a user-defined function (UDF), wherein the UDF is written in a programming language different from SQL;
translating, using a large language model (LLM), the UDF into a translated SQL query;
compiling the translated SQL query into a logical plan;
generating verification conditions for the logical plan;
translating the UDF into an intermediate verification language;
performing a verification process that matches the verification conditions to the intermediate verification language and verifies equivalence of the UDF and the translated SQL query; and
providing a verification result in response to performing the verification process.

2. The method of claim 1, further comprising:
inlining the translated SQL query with the parent SQL query in response to the verification result indicating that the verification process is successful; and
executing an inlined SQL query where the UDF is replaced with the translated query in the parent SQL query in providing a query result to the parent SQL query.

3. The method of claim 2, wherein inlining the translated SQL query with the parent SQL query includes replacing the UDF with the translated SQL query.

4. The method of claim 1, wherein the verification result indicates that the verification process is successful and that functions in the verification conditions provide a same result as functions in the intermediate verification language.

5. The method of claim 4, further comprising:
using the translated SQL query in place of the UDF in response to the verification result indicating that the verification process is successful.

6. The method of claim 1, wherein the verification result indicates that the verification process is unsuccessful and that functions in the verification conditions provide a different result as compared to functions in the intermediate verification language.

7. The method of claim 1, wherein the logical plan indicates a combination of operations in the translated SQL query and represents the translated SQL query in a sequence of operations.

8. The method of claim 1, wherein the verification conditions are a composition of uninterpreted functions identified by using SQL function mappings to SQL operator function properties and using equivalence rules.

9. The method of claim 1, wherein the UDF is written in a first programming language and the intermediate verification language is a modeling programming language different from the first programming language.

10. The method of claim 9, wherein the first programming language is translated into the modeling programming language by performing a series of transformations that are applied in any order and preserve semantics of the first programming language.

11. The method of claim 9, wherein the first programming language is translated into the modeling programming language by inferring types of input parameters to the UDF.

12. The method of claim 1, wherein the intermediate verification language is different from the programming language used for the UDF and SQL.

13. A device comprising:
a memory to store data and instructions; and
a processor operable to communicate with the memory, wherein the processor is operable to:
receive a parent structured query language (SQL) query with a user-defined function (UDF), wherein the UDF is written in a programming language different from SQL;
translate, using a large language model (LLM), the UDF into a translated SQL query;
compile the translated SQL query into a logical plan;
generate verification conditions for the logical plan;
translate the UDF into an intermediate verification language;
perform a verification process that matches the verification conditions to the intermediate verification language and verifies equivalence of the UDF and the translated SQL query; and
provide a verification result in response to performing the verification process.

14. The device of claim 13, wherein the processor is further operable to:
inline the translated SQL query with the parent SQL query by replacing the UDF in the parent SQL query with the translated SQL query in response to the verification result indicating that the verification process is successful; and
executing an inlined SQL query where the UDF is replaced with the translated query in the parent SQL query in providing a query result to the parent SQL query.

15. The device of claim 13, wherein the verification result indicates that the verification process is successful and that functions in the verification conditions provide a same result as functions in the intermediate verification language.

16. The device of claim 14, wherein the processor is further operable to:
use the translated SQL query in place of the UDF in response to the verification result indicating that the verification process is successful.

17. The device of claim 13, wherein the verification result indicates that the verification process is unsuccessful and that functions in the verification conditions provide a different result as compared to functions in the intermediate verification language.

18. The device of claim 17, wherein the logical plan indicates a combination of operations in the translated SQL query and represents the translated SQL query in a sequence of operations.

19. The device of claim 13, wherein the verification conditions are a composition of uninterpreted functions identified by using SQL function mappings to SQL operator function properties and using equivalence rules.

20. The device of claim 13, wherein the intermediate verification language is different from the programming language used for the UDF and SQL.
